(19) United States
(12) Patent Application Publication
(10) Pub. No.: US 2011/0124338 A1
(43) Pub. Date: May 26, 2011

(54) DELAYED GEOSPECIFIC MOBILE NUMBER ASSIGNMENT

(75) Inventors: Kevin R. Krause, Plymouth, MI (US); Fahd Z. Laghrari, Commerce Township, MI (US)

(73) Assignee: General Motors LLC, Detroit, MI (US)

(21) Appl. No.: 12/622,987

(22) Filed: Nov. 20, 2009

(51) Int. Cl. H04W 64/00

(52) U.S. Cl. 455/435.1

(57) ABSTRACT

A technique and system are provided for executing a delayed geographically specific activation procedure for a telematics unit associated with a vehicle. In an exemplary mode, the method includes first programming a memory of the telematics unit with geographically specific data including at least a location identifier specifying a geographic location and a PRL associated with the specified geographic location. After the vehicle is transported into the geographic location specified by the location identifier, the telematics unit detects that the vehicle is in the specified geographic location and responsively activates a PRL associated with the specified geographic location. Having access to the PRL, the telematics unit initiates a number assignment process over a wireless network extending within the specified geographic location via OTASP or a cleared number call, so that the telematics unit is assigned a dialing number associated with the specified geographic location.

### BACKGROUND OF THE INVENTION

An increasing number of vehicles include telematics and other wireless communications capabilities. As the demand for such vehicles increases in international markets, it has become important to assign mobile device numbers that are appropriate for the region in which a vehicle is sold and operated. While it is possible to custom design each vehicle's mobile communications systems for the eventual destination, it is generally disadvantageous to use different parts in the same model depending upon usage region. This part customization increases assembly complexity and also introduces layers of product tracking and support that would otherwise be unneeded in a one-location/one-part system.

Moreover, the assignment of specific phone numbers at the factory or production facility causes a number of further disadvantages. For example, such pre-assignment requires earlier activation with respect to each such number and ties up the number, so that it is unusable by others, for a longer period of time.

Thus there is an unfilled need for a system that is capable of automatically delaying number assignment and then assigning the number only when appropriate and in a manner that is nonetheless consistent with the region in which the vehicle is sold. Moreover, such a system should be capable of using a single part for all vehicles regardless of destination.

### BRIEF SUMMARY OF THE INVENTION

The invention provides an improved system, method, and mechanism for provisioning a mobile communication device associated with a vehicle regardless of the geographic region for which such device is provisioned, in a manner that delays the activation of a mobile number for the device until needed and that allows the manufacturer to utilize the same physical communications package regardless of the intended sale or use region for the vehicle.

In an example in keeping with the described principles, a method is provided for executing a delayed geographically specific activation procedure for a telematics unit associated with a vehicle. The method entails programming a memory of the telematics unit with geographically specific data including at least a location identifier specifying a geographic location and a PRL associated with the specified geographic location. Subsequently, the vehicle is transported such that it enters or remains in the geographic location specified by the location identifier and the telematics device detects that the vehicle is in the specified geographic location. The telematics device then activates the PRL associated with the specified geographic location and initiates a number assignment process over a wireless network extending within the specified geographic location, such that the telematics unit is assigned a dialing number associated with the specified geographic location.

It will be appreciated that other examples of the invention provide for a system and a computer-readable medium having computer-executable instruction for carrying out this and other methods in keeping with the described principles.

Other objects and advantages of the invention will become apparent upon reading the following detailed description and upon reference to the drawings.

### BRIEF DESCRIPTION OF THE SEVERAL VIEWS OF THE DRAWINGS

FIG. 1 is a schematic diagram of an operating environment for a mobile vehicle communication system;

FIG. 2 is a flow chart illustrating a process of geo-specific provisioning in accordance with the described principles of the invention;

FIG. 3 is a flow chart corresponding to a process for number assignment in a region supporting OTASP according to an aspect of the described principles;

FIG. 4 is a flow chart of a process for executing number assignment via the use of a cleared number call according to an aspect of the described principles, in the event that OTASP is unavailable, or is available but an attempted OTASP session failed;

FIG. 5 is a flow chart of an alternative process for executing number assignment according to an aspect of the described principles; and

FIG. 6 is a data chart showing an exemplary format and associated exemplary content with respect to the preprogrammed region-specific data usable in implementations of the described principles.

### DETAILED DESCRIPTION OF THE INVENTION

Before discussing the details of the invention and the environment wherein the invention may be used, a brief overview is given to guide the reader. In overview, not intended to limit the claims, the invention provides a system and method for presetting a mobile communication device associated with a vehicle to trigger when the vehicle reaches a specified the geographic region. Upon triggering, the device initiates a provisioning procedure to acquire a mobile dialing number and other data to allow activation and use. In general, the procedure involves first programming a destination region into the telematics unit at the vehicle assembly facility. Once the destination region has been programmed and the vehicle is shipped, the telematics unit detects that the vehicle has arrived in the appropriate destination and activates the PRL for that region, enabling the telematics unit to communicate over the available wireless network, e.g., to place a cleared number call or use OTASP to have a dialing number assigned by the carrier or other facility or entity.

As used herein, the term “cleared number” denotes a number that may be called from a device and that the network will let through regardless of the status of the device or the device's number. A cleared number is also known in the art as a “white-listed” or “non-validating” number.

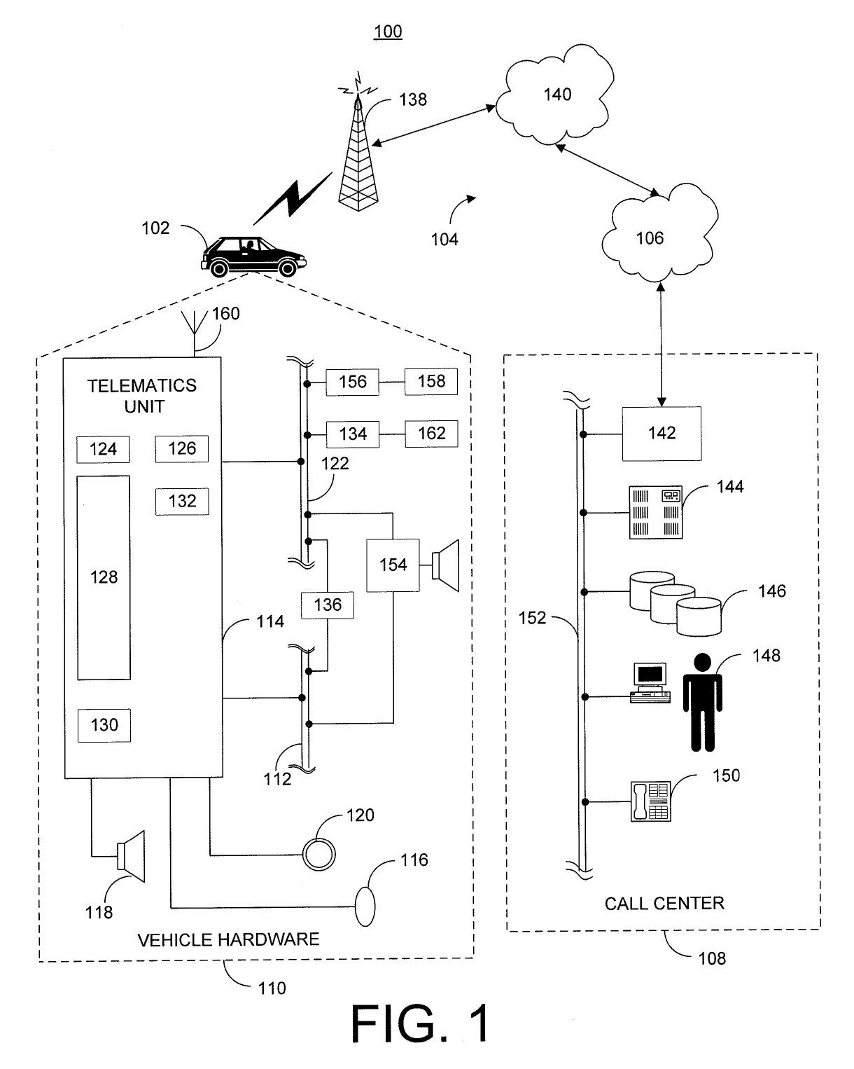

An exemplary environment in which the invention may operate is described hereinafter. It will be appreciated that the described environment is an example, and does not imply any limitation regarding the use of other environments to practice the invention. With reference to FIG. 1 there is shown an example of a communication system 100 that may be used with the present method and generally includes a vehicle 102, a wireless carrier system 104, a land network 106 and a call center 108. It should be appreciated that the overall architecture, setup and operation, as well as the individual components of a system such as that shown here are generally known in the art. Thus, the following paragraphs simply provide a brief overview of one such exemplary information system 100; however, other systems not shown here could employ the present method as well.

Vehicle 102 is preferably a mobile vehicle such as a motorcycle, car, truck, recreational vehicle (RV), boat, plane, etc., and is equipped with suitable hardware and software that enables it to communicate over system 100. Some of the vehicle hardware 110 is shown generally in FIG. 1 including a telematics unit 114, a microphone 116, a speaker 118 and buttons and/or controls 120 connected to the telematics unit 114. Operatively coupled to the telematics unit 114 is a network connection or vehicle bus 122. Examples of suitable network connections include a controller area network (CAN), a media oriented system transfer (MOST), a local interconnection network (LIN), an Ethernet, and other appropriate connections such as those that conform with known ISO, SAE, and IEEE standards and specifications, to name a few.

The telematics unit 114 is an onboard device that provides a variety of services through its communication with the call center 108, and generally includes an electronic processing device 128 one or more types of electronic memory 130, a cellular chipset/component 124, a wireless modem 126, a dual antenna 160 and a navigation unit containing a GPS chipset/component 132. In one example, the wireless modem 126 is comprised of a computer program and/or set of software routines executing within processing device 128. The cellular chipset/component 124 and the wireless modem 126 may be called the network access device (NAD) 180 of the telematics unit 114.

The telematics unit 114 provides too many services to list them all, but several examples include: turn-by-turn directions and other navigation-related services provided in conjunction with the GPS based chipset/component 132; airbag deployment notification and other emergency or roadside assistance-related services provided in connection with various crash and or collision sensor interface modules 156 and sensors 158 located throughout the vehicle; and Infotainment-related services where music, Web pages, movies, television programs, video games and/or other content is downloaded by an infotainment center 136 operatively connected to the telematics unit 114 via vehicle bus 122 and audio bus 112. In one example, downloaded content is stored for current or later playback.

Again, the above-listed services are by no means an exhaustive list of all the capabilities of telematics unit 114, as should be appreciated by those skilled in the art, but are simply an illustration of some of the services that the telematics unit 114 is capable of offering. It is anticipated that telematics unit 114 may include a number of known components in addition to those listed above.

Vehicle communications preferably use radio transmissions to establish a voice channel with wireless carrier system 104 so that both voice and data transmissions can be sent and received over the voice channel. Vehicle communications are enabled via the cellular chipset/component 124 for voice communications and a wireless modem 126 for data transmission. In order to enable successful data transmission over the voice channel, wireless modem 126 applies some type of encoding or modulation to convert the digital data so that it can communicate through a vocoder or speech codec incorporated in the cellular chipset/component 124. Any suitable encoding or modulation technique that provides an acceptable data rate and bit error can be used with the present method. Dual mode antenna 160 services the GPS chipset/component and the cellular chipset/component.

Microphone 116 provides the driver or other vehicle occupant with a means for inputting verbal or other auditory commands, and can be equipped with an embedded voice processing unit utilizing a human/machine interface (HMI) technology known in the art. Conversely, speaker 118 provides verbal output to the vehicle occupants and can be either a stand-alone speaker specifically dedicated for use with the telematics unit 114 or can be part of a vehicle audio component 154. In either event, microphone 116 and speaker 118 enable vehicle hardware 110 and call center 108 to communicate with the occupants through audible speech. The vehicle hardware also includes one or more buttons or controls 120 for enabling a vehicle occupant to activate or engage one or more of the vehicle hardware components 110. For example, one of the buttons 120 can be an electronic push button used to initiate voice communication with call center 108 (whether it be a live advisor 148 or an automated call response system). In another example, one of the buttons 120 can be used to initiate emergency services.

The audio component 154 is operatively connected to the vehicle bus 122 and the audio bus 112. The audio component 154 receives analog information, rendering it as sound, via the audio bus 112. Digital information is received via the vehicle bus 122. The audio component 154 provides AM and FM radio, CD, DVD, and multimedia functionality independent of the infotainment center 136. Audio component 154 may contain a speaker system, or may utilize speaker 118 via arbitration on vehicle bus 122 and/or audio bus 112.

The vehicle crash and/or collision detection sensor interface 156 are operatively connected to the vehicle bus 122. The crash sensors 158 provide information to the telematics unit 114 via the crash and/or collision detection sensor interface 156 regarding the severity of a vehicle collision, such as the angle of impact and the amount of force sustained.

Vehicle sensors 162, connected to various sensor interface modules 134 are operatively connected to the vehicle bus 122. Example vehicle sensors include but are not limited to gyroscopes, accelerometers, magnetometers, emission detection and/or control sensors, and the like. Example sensor interface modules 134 include power train control, climate control, and body control, to name but a few.

Wireless carrier system 104 is preferably a cellular telephone system or any other suitable wireless system that transmits signals between the vehicle hardware 110 and land network 106. According to an example, wireless carrier system 104 includes one or more cell towers 138, base stations and/or mobile switching centers (MSCs) 140, as well as any other networking components required to connect the wireless system 104 with land network 106. A component in the mobile switching center may include a remote data server 180. As appreciated by those skilled in the art, various cell tower/base station/MSC arrangements are possible and could be used with wireless system 104. For example, a base station and a cell tower could be co-located at the same site or they could be remotely located, and a single base station could be coupled to various cell towers or various base stations could be coupled with a single MSC, to but a few of the possible arrangements. Preferably, a speech codec or vocoder is incorporated in one or more of the base stations, but depending on the particular architecture of the wireless network, it could be incorporated within a Mobile Switching Center or some other network components as well.

Land network 106 can be a conventional land-based telecommunications network that is connected to one or more landline telephones and connects wireless carrier network 104 to call center 108. For example, land network 106 can include a public switched telephone network (PSTN) and/or an Internet protocol (IP) network, as is appreciated by those skilled in the art. Of course, one or more segments of the land network 106 can be implemented in the form of a standard wired network, a fiber or other optical network, a cable network, other wireless networks such as wireless local networks (WLANs) or networks providing broadband wireless access (BWA), or any combination thereof.

Call Center (OCC) 108 is designed to provide the vehicle hardware 110 with a number of different system back-end functions and, according to the example shown here, generally includes one or more switches 142, servers 144, databases 146, live advisors 148, as well as a variety of other telecommunication and computer equipment 150 that is known to those skilled in the art. These various call center components are preferably coupled to one another via a network connection or bus 152, such as the one previously described in connection with the vehicle hardware 110. Switch 142, which can be a private branch exchange (PBX) switch, routes incoming signals so that voice transmissions are usually sent to either the live advisor 148 or an automated response system, and data transmissions are passed on to a modem or other piece of equipment 150 for demodulation and further signal processing.

The modem 150 preferably includes an encoder, as previously explained, and can be connected to various devices such as a server 144 and database 146. For example, database 146 could be designed to store subscriber profile records, subscriber behavioral patterns, or any other pertinent subscriber information. Although the illustrated example has been described as it would be used in conjunction with a manned call center 108, it will be appreciated that the call center 108 can be any central or remote facility, manned or unmanned, mobile or fixed, to or from which it is desirable to exchange voice and data.

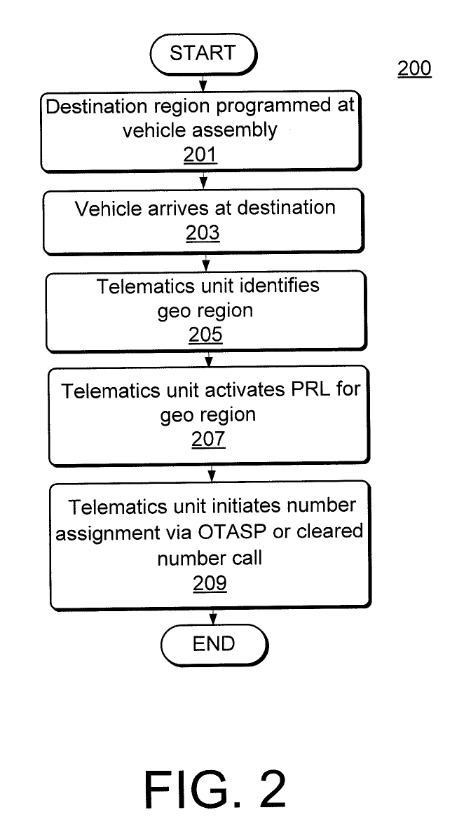

Before turning to FIG. 2, a brief overview of the invention will be given. As noted above, the onboard telematics unit 114 provides many services based on unidirectional or bidirectional communication with the call center 108. To execute the needed communications, regardless of the underlying content, the telematics unit 114 employs primarily the cellular chipset 124 (for voice data) or wireless modem 126 (for digital data) and antenna 160. In either case, the communications link is enabled by the wireless carrier system 104. This requires that the telematics unit 114 have a unique mobile number recognized by the wireless carrier system 104.

Because different wireless carriers have different protocols, number series, number lengths, and so on, the proper assignment of an appropriate number is a location-dependent endeavor. In this regard, as noted above, the best solution heretofore known was to create a unique version of the telematics unit 114 for each location to which vehicles may ship. However, this practice carries numerous attendant disadvantages, not the least of which is the addition of substantial complexity to the production process.

To eliminate the disadvantages inherent in prior approaches, the process and system described herein provide a means of assigning, activating, and programming phone numbers for telematics modules which are local to the country or region where the vehicle is to be used. This method allows the use of a global telematics module such that the same part can be reused for all vehicles worldwide. Put another way, the principles described herein allow for the simple and efficient automation of phone number assignment based on the vehicle destination.

In overview, during assembly, the vehicle communication package (VCP) is programmed with its destination region code (e.g. U.S., Germany, Spain, etc.). The module uses GPS (geo-boundaries), or a combination of GPS and available networks, to determine when it reaches the programmed geographic region. Once arrival in the programmed locale is determined, the telematics module refers to an internal table that holds network configuration data corresponding to each region, and applies settings as needed. For example, this may include loading a specific PRL (preferred roaming list) for the programmed region as well as updating over-the-air programming codes and call center phone numbers. A number of PRLs may be stored in the memory of the telematics module and loaded into the NAD as necessary. After loading the PRL and acquiring service, the telematics module then requests that a phone number be assigned to it based on the method defined within the table for that particular region. This may be accomplished using over the air service provisioning (OTASP) and/or connecting directly to a service provider using a cleared number (data call), or another method, depending on the region and the current system's capabilities.

Any region may have a unique OTASP number as well as a cleared number as appropriate for the region identified. In a given region, OTASP may be the primary method for programming and use of a cleared number may be the secondary method, i.e., if OTASP fails. Alternatively, certain regions may only support either OTASP or the cleared number method, but not both.

Turning to further specific details regarding the invention, FIG. 2 is a flow chart illustrating a process 200 of geo-specific provisioning in overview, to aid understanding of later discussions directed to specific aspects of the described principles. At stage 201 of process 200, a destination region is programmed into the telematics unit 114 at the vehicle assembly facility. The step of programming this information at stage 201 may be automatically executed or may be executed by personnel associated with the assembly process. The destination region may be indicated by an alphanumeric, purely numeric, or alphabetical code, as desired and appropriate for each implementation, and may or may not be human understandable. For example, the region corresponding to Germany may be indicated by DE, GER, G123, 123, or otherwise as desired. The complexity of the codes will depend upon the number of potential delivery regions and the existence of overlapping aspects of those regions, i.e., EURope and EURasia (one or both of which would require more than simply “EUR” as a unique identifier in a purely alphabetical system).

Once the destination region has been programmed into the telematics unit 114 at stage 201, the process flows to stage 203, whereupon the vehicle is sent for delivery and arrives at its assigned destination after appropriate shipping and transport through one or more channels. It will be appreciated that in some cases, the region of manufacture may also correspond to the region of delivery, in which case shipping may be minimal or nonexistent. For example, a vehicle assembled in Germany may be destined for delivery to a German dealer. In such a case, the vehicle may already reside in the programmed locale without further travel.

The telematics unit 114 detects in stage 205 that the vehicle has arrived in (or already resided in) the appropriate destination. This determination may be made via a GPS location measurement or via analysis of wireless system ID information when a wireless network becomes available, or may be made using both techniques in parallel. For example, even without the use of GPS, the identity of detectable local wireless networks may signify the vehicle location, due to the local nature of carriers. That is, since cell signals and other similar wireless signals are relatively short range, i.e., having a range that is much smaller than most countries and distinct geographical regions, the identity of a detected base station serves as a reasonable indicator of location, with a resolution equal to the cell size.

Having determined at stage 205 that the vehicle is in the assigned location, the telematics unit 114 then activates the PRL for that region at stage 207. This enables the telematics unit 114 to communicate over the available wireless network, at least to the extent of placing cleared number calls.

At stage 209, the telematics unit 114 causes the assignment of a number and other indicia to the unit via one of an OTASP session or a cleared number call to the carrier or other facility. These various methods will be discussed in greater detail with respect to subsequent figures.

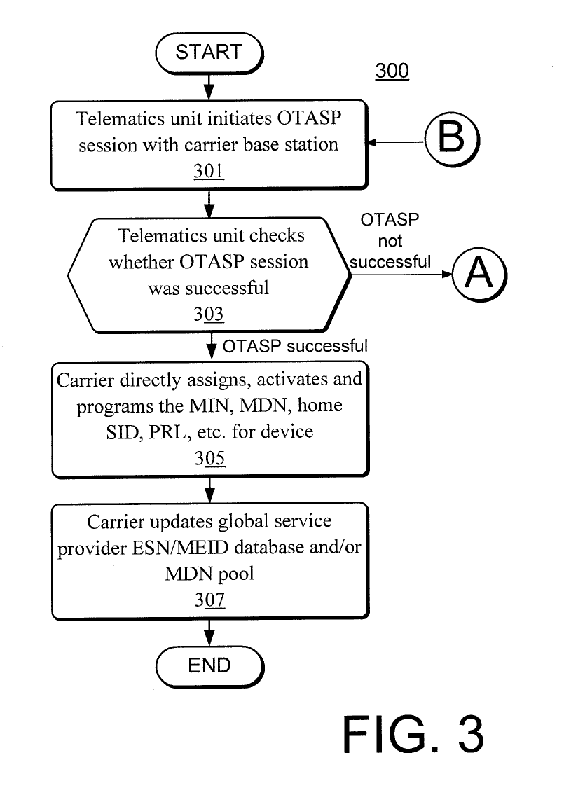

FIG. 3 is a flow chart corresponding to a process 300 for number assignment in a region supporting OTASP. It will be appreciated that a mobile device may determine, via analysis of signals received from a base station, whether the network supports OTASP. At stage 301 of process 300, the telematics unit 114 initiates an OTASP session by transmission of an appropriate code to the carrier base station in communication with the device. Although a region and a particular network may support OTASP capabilities, it is nonetheless possible that an OTASP session may fail for any one of a number of different reasons.

Because of this possibility, the telematics unit 114 checks in stage 303 as to whether the OTASP session was successful. If the OTASP session was successful, then the process 300 flows to stage 305, wherein the carrier directly assigns, activates and programs the MIN, MDN, home SID, PRL, etc. for the device. Subsequently at stage 307, the carrier updates all relevant directories and/or databases, e.g., a global service provider ESN/MEID database and/or MDN pool, with the assigned information.

If, on the other hand, it is determined at stage 303 that the OTASP session was not successfully executed, the process 300 flows instead to transition A, which is an entry point to process 400, described hereinafter.

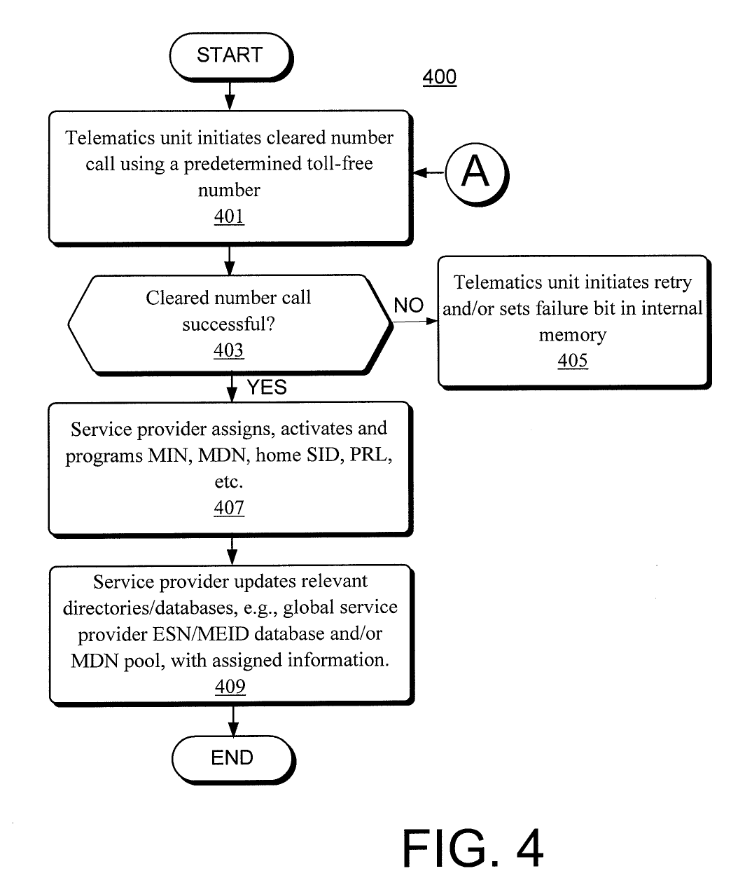

FIG. 4 shows a flow chart of a process 400 for executing number assignment via the use of a cleared number call, in the event that OTASP is unavailable, or is available but an attempted OTASP session failed. At stage 401 of process 400, the telematics unit initiates a cleared number call using a predetermined number. The process 400 then flows to stage 403, wherein the telematics unit 114 determines whether the cleared number call was successful.

If it is determined at stage 403 that the cleared number call was not successful, the process flows to stage 405, wherein the telematics unit 114 initiates a retry and/or sets a failure bit, (e.g. sets DTC), in internal memory. If it is determined at stage 403 that the cleared number call was successful, the process flows to stage 407, wherein the service provider assigns, activates and programs MIN, MDN, home SID, PRL, etc. Subsequently at stage 409, the service provider updates all relevant directories and/or databases, e.g., a global service provider ESN/MEID database and/or MDN pool, with the assigned information.

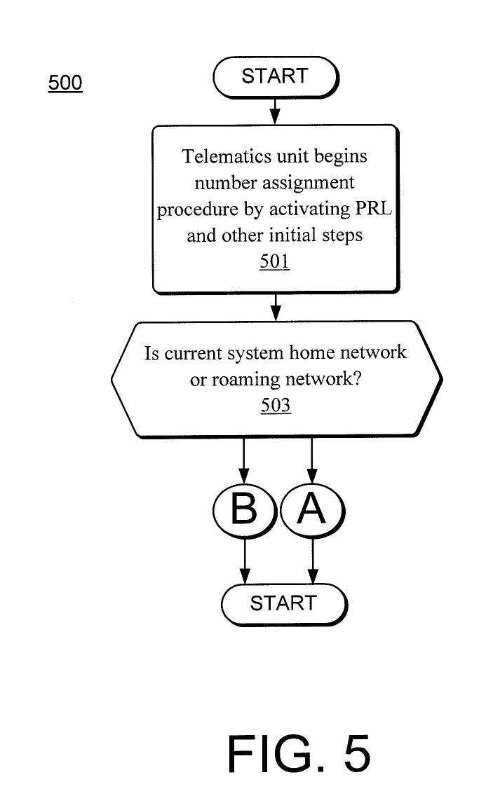

It will be recalled that the decision between execution of process 300 and execution of process 400 was made based on whether the relevant carrier supports OTASP, and, if OTASP is supported, whether OTASP was successful. In an alternative implementation of the invention illustrated in FIG. 5, the decision as to which method to use begins with an alternative analysis. In particular, at stage 501 of process 500, the telematics unit 114 begins the number assignment procedure, e.g., by activating the PRL and any other necessary initial steps.

Next at stage 503, the telematics unit determines whether the current system is a home network or roaming network. A home network is one provided by the device's service provider within a plan for the device, while a roaming network is one outside of the plan. For example, a calling plan that covers only the Detroit metropolitan area will allow a user to make calls elsewhere, but typically only via a roaming network. If it is determined at stage 503 that the current system is a home network, then the process 500 flows to transition point A in process 300. If, on the other hand, it is determined that the current system is a roaming network, then the process flows to transition point B in process 400. In this way, the most cost effective means of number assignment may be used.

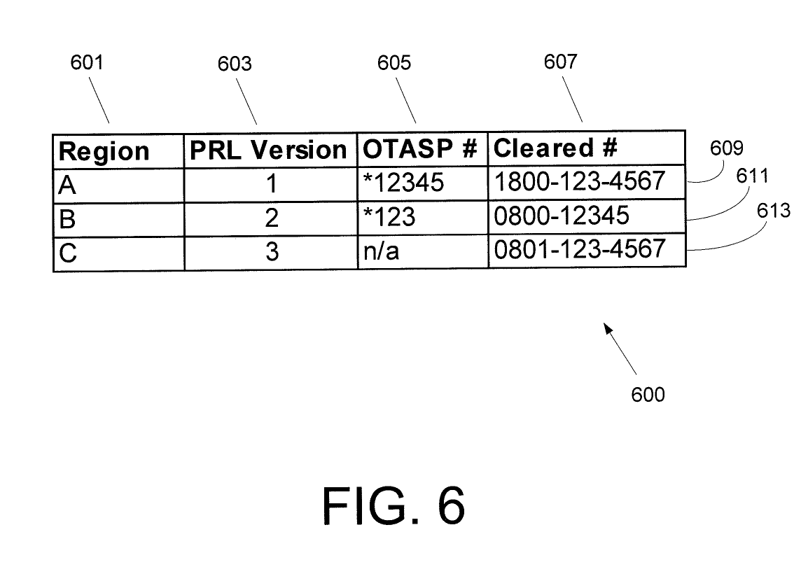

As was noted above, the vehicle communication package is programmed during assembly or preparation with a specific destination region code (e.g. U.S., Germany, Spain, etc.). This information along with other necessary information is stored in a memory associated with the telematics unit 114, e.g., in electronic memory 130. Although this information need not be stored in a particular form or format for every implementation of the invention, an exemplary tabular format and associated exemplary content are illustrated in the data chart 600 of FIG. 6.

In the illustrated example, the data chart 600 includes data for three regions, namely region A 609, region B 611, and region C 613. For each region 609, 611, 613, the chart 600 specifies four categories of data including a region identifier 601, a PRL version number 603, an OTASP number 605, and a cleared number 607. Thus, the illustrated chart 600 indicates that for Region A, the specified PRL version is “1,” the OTASP number is “*12345,” and the cleared number is “1-800-123-4567.” Similarly, the data for Region B is PRL:2, OTASP:*123, and Cleared Number:0800-12345, and for Region C, the specified data is PRL:3, OTASP:n/a, and Cleared Number:0801-123-4567. Again, it will be appreciated that the form, format, and content of the data structure 600 is not critical so long as it provides sufficient data to execute a delayed automatic number assignment in keeping with the disclosed principles

More generally, it will now be fully appreciated that the described system and method are capable of providing a number of substantial benefits, including economies of scale as well as the ease of supply and tracking provided by using a single part regardless of destination. Moreover, the cost and complication of activating phone numbers long prior to actual use are largely eliminated.

It will be appreciated that the foregoing methods and implementations for delayed geo-specific mobile number assignment are merely examples of the inventive principles, and that these illustrate only preferred techniques. It is contemplated that other implementations of the invention may differ in detail from the foregoing examples. As such, all references to the invention are intended to reference the particular example of the invention being discussed at that point in the description and are not intended to imply any limitation as to the scope of the invention more generally. All language of distinction and disparagement with respect to certain features is intended to indicate a lack of preference for those features, but not to exclude such from the scope of the invention entirely unless otherwise indicated.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. A method of executing a delayed geographically specific activation procedure for a telematics unit associated with a vehicle, the method comprising, in order:
programming a memory of the telematics unit with geographically specific data including at least a location identifier specifying a geographic location and a PRL associated with the specified geographic location;
causing the vehicle to be transported such that it enters or remains in the geographic location specified by the location identifier;
detecting at the telematics unit that the vehicle is in the geographic location specified by the location identifier, and in response to detecting at the telematics unit that the vehicle is in the geographic location specified by the location identifier, activating the PRL associated with the specified geographic location; and
initiating a number assignment process over a wireless network extending within the specified geographic location, whereby the telematics unit is assigned a dialing number associated with the specified geographic location.

2. The method of claim 1, wherein programming a memory of the telematics unit with geographically specific data including at least a location identifier specifying a geographic location and a PRL associated with the specified geographic location further includes programming a memory of the telematics unit with one or more OTASP numbers associated with the specified geographic location and one or more cleared numbers.

3. The method according to claim 1, wherein the step of detecting at the telematics unit that the vehicle is in the geographic location specified by the location identifier comprises analyzing GPS data and detecting based on the analyzed GPS data that the vehicle is in the geographic location specified by the location identifier.

4. The method according to claim 1, wherein the step of detecting at the telematics unit that the vehicle is in the geographic location specified by the location identifier comprises detecting the presence of wireless signals emanating from a base station associated with the geographic location specified by the location identifier.

5. The method according to claim 1, wherein the step of activating the PRL associated with the specified geographic location comprises reading a computer-readable memory containing indicators for multiple PRLs and selecting a PRL associated with the specified geographic location.

6. The method according to claim 2, wherein initiating a number assignment process over a wireless network extending within the specified geographic location comprises placing an OTASP call.

7. The method according to claim 2, wherein initiating a number assignment process over a wireless network extending within the specified geographic location comprises placing a cleared number call.

8. The method of claim 1, wherein initiating a number assignment process over a wireless network extending within the specified geographic location comprises:
placing an OTASP call requesting a number assignment;
receiving a number assignment if the OTASP call is successful, and otherwise placing a cleared number call and receiving a number assignment via the cleared number call; and
updating the telematics unit with the received number assignment.

9. The method of claim 8, wherein, wherein each step of receiving a number assignment includes receiving an assignment of an MIN, MDN, home SID, and PRL for the telematics unit.

10. A computer-readable medium having thereon computer-executable instructions for executing a delayed geographically specific activation procedure for a telematics unit associated with a vehicle, the computer-executable instructions comprising, in order:
instructions for reading a memory of the telematics unit having stored therein geographically specific data including at least a location identifier specifying a geographic location and a PRL associated with the specified geographic location;
instructions for detecting that the vehicle is in the geographic location specified by the location identifier, and in response to detecting at the telematics unit that the vehicle is in the geographic location specified by the location identifier, activating the PRL associated with the specified geographic location; and
instructions for initiating a number assignment process over a wireless network extending within the specified geographic location, whereby the telematics unit is assigned a dialing number associated with the specified geographic location.

11. The computer-readable medium of claim 10, wherein the memory of the telematics unit has stored therein one or more OTASP numbers associated with the specified geographic location and one or more cleared numbers.

12. The computer-readable medium according to claim 10, wherein the instructions for detecting that the vehicle is in the geographic location specified by the location identifier comprise instructions for analyzing GPS data and detecting based on the analyzed GPS data that the vehicle is in the geographic location specified by the location identifier.

13. The computer-readable medium according to claim 10, wherein the instructions for detecting that the vehicle is in the geographic location specified by the location identifier comprise instructions for detecting the presence of wireless signals emanating from a base station associated with the geographic location specified by the location identifier.

14. The computer-readable medium according to claim 10, wherein the instructions for activating the PRL associated with the specified geographic location comprise instructions for reading a computer-readable memory containing indicators for multiple PRLs and selecting a PRL associated with the specified geographic location.

15. The computer-readable medium according to claim 11, wherein the instructions for initiating a number assignment process over a wireless network extending within the specified geographic location comprise instructions for placing an OTASP call.

16. The computer-readable medium according to claim 11, wherein the instructions for initiating a number assignment process over a wireless network extending within the specified geographic location comprise instructions for placing a cleared number call.

17. The computer-readable medium of claim 10, wherein the instructions for initiating a number assignment process over a wireless network extending within the specified geographic location comprise:
instructions for placing an OTASP call requesting a number assignment;
instructions for receiving a number assignment if the OTASP call is successful, and otherwise placing a cleared number call and receiving a number assignment via the cleared number call; and
instructions for updating the telematics unit with the received number assignment.

18. The computer-readable medium of claim 17, wherein the instructions for receiving a number assignment include instructions for receiving an assignment of an MIN, MDN, home SID, and PRL for the telematics unit.

19. A telematics unit for use in a vehicle and for facilitating delayed automatic number assignment, the telematics unit comprising:
a communications link for wirelessly communicating over a wireless network;
a computer-readable memory containing:
geographically specific data including at least a location identifier specifying a geographic location and a PRL associated with the specified geographic location;
computer-executable instructions for executing a delayed automatic number assignment including:
instructions for detecting that the vehicle is in the geographic location specified by the location identifier, and in response to detecting at the telematics unit that the vehicle is in the geographic location specified by the location identifier, activating the PRL associated with the specified geographic location; and
instructions for initiating over the wireless network via the communications link a number assignment process, whereby the telematics unit is assigned a dialing number associated with the specified geographic location.

20. The telematics unit according to claim 19, wherein the computer-executable instructions for initiating a number assignment process further include instructions for:
placing an OTASP call requesting a number assignment;
receiving a number assignment if the OTASP call is successful, and otherwise placing a cleared number call and receiving a number assignment via the cleared number call; and
updating the telematics unit with the received number assignment.
